(19) United States
(12) Patent Application Publication
(10) Pub. No.: US 2009/0050091 A1
(43) Pub. Date: Feb. 26, 2009

(54) CAM FOLLOWER APPARATUS

(75) Inventors: Makoto Watanabe, Kanagawa (JP); Satoshi Kadokawa, Kanagawa (JP)

Correspondence Address: SUGHRUE-265550, 2100 PENNSYLVANIA AVE. NW, WASHINGTON, DC, 20037-3213, US

(73) Assignee: NSK LTD., Tokyo (JP)

(21) Appl. No.: 11/813,932

(22) PCT Filed: Feb. 12, 2006
(86) PCT No.: PCT/JP2006/300287

§ 371 Date: Jul. 13, 2007

(30) Foreign Application Priority Data
Jan. 20, 2005 (JP) 2005-012831
Jan. 13, 2006 (JP) 2005-005909

(51) Int. Cl. F01L 1/18; F16C 19/24; F01L 1/14

(52) U.S. Cl. 123/90.44; 384/548; 123/90.48

(57) ABSTRACT

As this radial needle bearing 7c, a radial needle bearing is used which includes a cage 10b. Respective pillar portions 12, 12 which make up the cage 10b are disposed more radially inwards than a circle pitch of respective needles 8, 8. In addition, the needles 8, 8 which are adjacent to each other in a circumferential direction are caused to approach each other, so as to secure the number of such needles 8, 8. As a result, no large bending stress is applied to a tappet roller 6 without increasing the thickness of the tappet roller 6.

### TECHNICAL FIELD

A cam follower apparatus according to the present invention is used as a component of an intake and exhaust valve driving system of an engine which transforms rotations of a camshaft into reciprocating oscillating motions of rocker arms.

### BACKGROUND ART

With a view to realizing a reduction in friction in an interior of an engine so as to reduce the fuel consumption rate, it is general practice to utilize a cam follower apparatus which incorporates therein a tappet roller in a portion where rotations of a camshaft which are in synchronous with those of a crankshaft are transformed into reciprocating motions of intake valves and exhaust valves. FIGS. 18 to 20 show an example of a cam follower apparatus with a tappet roller incorporated therein which is described in Patent Document No. 1.

A rocker arm 3 is provided which faces a cam 2 fixed (generally, integrally formed with) on to a camshaft 1 which rotates in synchronous with a crankshaft of an engine and oscillates in a reciprocating fashion when receiving the movement of the cam 2. A pair of support wall portions 4, 4 is provided at an end portion of the rocker arm 3 (there being a case where they are provided at an intermediate portion) in such a manner as to be space apart from each other. In addition, a steel, hollow or solid support shaft 5 is extended between the pair of support walls 4, 4. This support shaft 5 is fixed to the pair of support walls 4, 4 at both end portions thereof, so as to rotatably support a tappet roller 6 via a radial needle bearing 7. In addition, an outer circumferential surface of the tappet roller 6 is brought into abutment with an outer circumferential surface of the cam 2. According to a valve train which incorporates therein the tappet roller 6 that is configured as has been described above, a friction force acting between the rocker arm 3 and the cam 2 is reduced, so as to realize a reduction in fuel consumption rate while the engine is running.

As a radial needle bearing 7 which is incorporated in the cam follower apparatus that has been described above, conventionally, a so-called complete needle type radial needle bearing has been used in which as is shown in FIGS. 21 to 22, only needles 8, 8 are disposed between an outer circumferential surface of a support shaft 5 and an inner circumferential surface of a tappet roller 6 (neither cage nor separator being disposed). In the complete needle type radial needle bearing 7 like this, however, as is obvious from arrows shown in FIG. 22 which indicate rotational directions of the respective needles 8, 8, it is inevitable that rolling surfaces of needles 8, 8 which are adjacent to each other in a circumferential direction are caused to rub against each other. As a result of this, the rotational resistance (the dynamic torque) of the radial needle bearing 7 is increased, and the rotational resistance of the tappet roller 6 cannot necessarily be reduced sufficiently.

In order to suppress the increase in rotational resistance of the radial needle bearing due to the cause mentioned above, it is considered to utilize a radial needle bearing which includes a cage or separator as this radial needle bearing. In order to rotatably support a roller-like member such as a tappet roller on the periphery of the support shaft, there have conventionally been known as a construction in which a radial needle bearing with a cage is provided constructions which are described in Patent Document Nos. 2, 3.

FIG. 23 shows, of those constructions, the construction described in Patent Document No. 2. The construction shown in FIG. 23 is such as to be incorporated in a cam mechanism portion of an office machine or the like, in which a cylindrical roller 9 is rotatably supported on the periphery of a distal end portion of a support shaft 5a by a radial needle bearing 7a which includes a cage 10 made from an oil contained synthetic resin.

In addition, FIG. 24 shows the construction described in Patent Document No. 3. In this construction shown in FIG. 24, a roller 9a, which makes up a friction roller type transmission which is incorporated in an electric vehicle or an electric wheelchair, is rotatably supported on the periphery of a support shaft 5b by a radial needle bearing 7b which includes a case 10a.

Furthermore, as a method for producing a metallic cage for a radial needle bearing, there have conventionally been known various methods described in various documents such as Patent Document Nos. 4 to 6.

In the case of the conventional constructions shown in FIGS. 23, 24, while the rotational resistance (the dynamic torque) of the radial needle bearings 7a, 7b is reduced, no consideration is taken as to securing a load carrying capacity. Namely, in the case of the radial needle bearings 7a, 7b which are incorporated in the conventional constructions, since only holding the plurality of needles 8, 8 simply in the cage 10, 10a is taken into consideration, the number of needles 8, 8 which make up the radial needle bearings 7a, 7b becomes excessively small. For example, when considering a cam follower apparatus which is incorporated in an engine for a general passenger vehicle, according to the complete needle type radial needle bearing 7 shown in FIG. 22, about 15 needles can be secured as the number of needles 8, 8. Consequently, an interval between the needles 8, 8 which are adjacent to each other in the circumferential direction can be suppressed to a short interval. In contrast to this, in the case of the radial needle bearings 7a, 7b with a cage according to the conventional constructions, as is shown in FIG. 25, the number of needles 8, 8 is reduced largely to of the order 10. As a result of this, the interval between the needles 8, 8 which are adjacent to each other in the circumferential direction becomes largely wide.

In the case of the conventional constructions shown in FIGS. 23, 24, a large radial load is in no case applied locally to outer circumferential surfaces of the rollers 9, 9a supported by the radial needle bearings 7a, 7b. Because of this, even though the interval between the needles 8, 8 which are adjacent in the circumferential direction is wide as has been described above, there is caused no specific problem from the view point of securing the durability. In contrast to this, in the case of the cam follower apparatus which is the object of the invention, since the cam follower is used as the constituent component of the intake and exhaust valve driving system of the engine which transforms rotations of the camshaft into reciprocating oscillating motions of rocker arms, a large radial load is applied locally to the outer circumferential surface of the tappet roller when the engine is running. Because of this, when the interval between the needles 8, 8 which are adjacent to each other in the circumferential direction is wide, a large bending stress becomes easy to be applied repeatedly to the tappet roller, and it becomes difficult to make reducing the weight of the tappet roller compatible with securing the durability.

Namely, in order to secure the durability of the tappet roller irrespective the bending stress, a thickness relative to a radial direction of the tappet roller has to be increased. This tappet roller is a member which moves backwards and forwards at high speeds when the engine is running, and in order to increase the performance of the engine, the weight of the tapped roller has to be reduced as much as possible. Because of this, although it can help to reduce the rotational resistance of the radial needle bearing, increasing the thickness of the tappet roller is not preferable.

Patent Document No. 1: Japanese Patent Unexamined Publication JP-A-3-78507

Patent Document No. 2: Japanese Patent Unexamined Publication JP-A-2000-145791

Patent Document No. 3: Japanese Patent Unexamined Publication JP-A-2002-70972

Patent Document No. 4: Japanese Patent Unexamined Publication JP-A-8-270658

Patent Document No. 5: Japanese Patent Unexamined Publication JP-A-7-151153

Patent Document No. 6: Japanese Patent Unexamined Publication JP-A-2000-257638

### DISCLOSURE OF THE INVENTION

### Problem that the Invention is to Solve

In view of the situations, the invention was made with a view to realizing a reduction in rotational resistance of a radial needle bearing which supports a tappet roller on a support shaft without increasing a thickness of the tappet roller.

### Means for Solving the Problem

Similarly to the conventional cam follower apparatus that has been described above, a cam follower apparatus of the invention includes a support shaft and a tappet roller.

The end portions of the support shaft is supported on a rocking member, which is provided so as to face a cam fixed to a camshaft which rotates in synchronous with a crankshaft of an engine and which rocks in accordance with motions of the cam.

Furthermore, the tappet roller is rotatably supported on the periphery of the support shaft via a radial needle bearing.

In particular, in the cam follower apparatus of the invention, a plurality of needles which make up the radial needle bearing are separated apart by separating elements which are disposed parallel to a center axis of the support shaft between the needles which are adjacent to each other in a circumferential direction in such a state that rolling surfaces of the adjacent needles are not brought into contact with each other. In addition, a thickness of the respective separating elements relative to a radial direction of the support shaft and the tappet roller is smaller than a diameter of the respective needles. In addition, one side of internal and external sides of the respective separating elements is brought into sliding contact with or is caused to face closely one circumferential surface of an inner circumferential surface of the tappet roller and an outer circumferential surface of the support shaft so as to realize the positioning relative to the radial direction. In addition, a space, which is larger than a space existing between the one side and the one circumferential surface, exits between the other side of the internal and external sides of the respective separating element and the other circumferential surface of the inner circumferential surface of the tappet roller and the outer circumferential surface of the support shaft.

In addition, in carrying out the invention, preferably, according to a second aspect of the invention, the respective separating elements is made up of a pillar portion which makes up a window type cage. In addition, a pair of rim portions to which both end portions of the respective pillar portions are connected is disposed, respectively, between both axial end faces of the respective needles and internal sides of a pair of support wall portions which are provided on a rocking member for supporting and fixing both end portions of the support shaft.

By being configured like this, the axial end faces of the respective needles are prevented from butting a part of the sides of the rocking member which supports the end portions of the support shaft, so as to suppress the wear of the part of the sides. Namely, the rocking member such as the rocker arm which reciprocates at high speeds is sometimes made of a relatively soft light metal such as an aluminum alloy in order to reduce the weight thereof. When the respective needles rotate about the support shaft in such a state that the axial end faces of the respective needles which are made of a hard metal such as a bearing steel (or a ceramic) butt the part of the sides of the rocking member of such a light metal (by virtue of an axial movement based on skewing), there is caused a possibility that a remarkable wear is generated on the part of the sides.

By adopting a construction according to the second aspect of the invention, the generation of a remarkable wear on the part of the sides can be prevented in an ensured fashion.

In addition, in implementing a construction according to the second aspect of the invention, preferably, as described in the third aspect of the invention, a locking portion is provided on an inner surface of a respective pocket which is surrounded on four sides thereof by pillar portions which are adjacent to each other in a circumferential direction and the pair of rim portions for preventing the dislocation of the needle held within the respective pockets from the pocket.

As the locking member like this, it is considered to form a small projection which projects from both circumferential sides of the respective pillar portion or sides of both the rim portions which face each other towards an inside of the respective pocket. When causing the respective needle to be held within the respective pocket, the needle is pushed into the respective pocket while elastically displacing the respective small projection. Since, after the needle has been so pushed in, a space defined between distal ends of the small projections which face each other becomes smaller than the diameter of the respective needle, there occurs no case where the respective needle is dislocated abruptly from the inside of the respective pocket.

By adopting the construction like this, since the cage and the plurality of needles held by the cage are handled as the so-called cage-and-rollers in which the cage and the needles are connected in such a manner as not to be separated, simplification in parts control and increase in assembling properties of the cam follower apparatus can be realized.

In addition, when carrying out the invention, for example, according to a fourth aspect of the invention, the respective separating elements can be made into rod-like separators which are independent of each other.

When employing a construction in which such separators are used, although the butting of the axial end faces of the respective needle against the part of the sides of the rocking member cannot be prevented, in stead, an axial dimension of the respective needle can be increased (by such an extent which equals the thickness of the rim portions). The fact that the axial end faces of the respective needle butt part of the sides of the rocking member is not particularly a problem in the event that the rocking member is made of a hard metal such as steel or a washer made of a hard metal or synthetic resin is provided at portions on the part of the sides which face the axial end faces of the respective needle. The increase in the axial dimension of the respective needle results in an increase in the load carrying capacity of the radial needle bearing and leads to an increase in durability of the cam follower apparatus. In addition, in the event that the load carrying capacity may stay the same, the axial dimensions of the radial needle bearing and the tappet roller are reduced (by an extent which equals the axial dimension of the rim portions), thereby making it possible to reduce the size and weight of the cam follower apparatus.

In addition, when carrying out the invention, preferably, according to a fifth aspect of the invention, a carbonitride layer is formed on at least one surface of the outer circumferential surface of the support shaft and the rolling surface of the respective needle.

By adopting the configuration like this, the outer circumferential surface of the support shaft and the rolling surface of the respective needle are prevented from being damaged, thereby making it possible to realize the cam follower apparatus which has superior durability.

In addition, in the event that the respective separating element (the cage or separator) is made from a synthetic resin, a friction coefficient of sliding portions between circumferential sides of the respective separating element and the rolling surface of the needle made of a metal or ceramic (generally, made of steel such as a bearing steel) is suppressed lower when compared with a friction coefficient which results in the event that the rolling surfaces of the needles rub against each other. In addition, with the respective separating element made from the synthetic resin, the molding thereof becomes easy and inexpensive, and in addition to this, since the respective separating element is light in weight, the cam follower apparatus of the invention is advantageous in lowering the production costs and in increasing the performance of an engine when incorporated in the engine.

In addition, it is a preferred embodiment that the respective separating element (the cage or separator) is produced by means of a metal injection molding of a light alloy such as a magnesium alloy. In the event that the respective separating element is produced through powder metallurgy of a light metal material, not only is a reduction in weight of the respective separating element realized but also an increase in efficiency is realized with which the production work of producing the respective separating element of a complicated configuration is performed.

### ADVANTAGE OF THE INVENTION

In the case of the cam follower apparatus of the invention which is configured as has been described heretofore, there occurs no case where the rolling surfaces of the needles which are adjacent in the circumferential direction rub against each other. Although the rolling surfaces of the respective needles and the circumferential sides of the respective separating elements rub against each other, the rubbing speed is slower than (is suppressed to ½) that resulting where the rolling surfaces of the needles which are adjacent in the circumferential direction rub against each other. Because of this, the dynamic torque of the radial needle bearing is suppressed to a low level, whereby the rotational resistance of the tappet roller is suppressed to a low level.

Furthermore, the thickness of the respective separating element is smaller than the diameter of the respective needle, and moreover, the radial position of the respective separating element is offset relative the radial position of the respective needle (the pitch circle diameter of the respective needles and the pitch circle diameter of the respective separating elements are made to differ). Because of this, the interval between the rolling surfaces of the needles which are adjacent in the circumferential direction can be reduced to become narrower than the circumferential width of the respective separating element so as to secure the number of needles which are disposed between the outer circumferential surface of the support shaft and the inner circumferential surface of the tappet roller. As a result, a bending stress generated on the tapped roller when the engine is running can be suppressed to a small level without increasing the thickness of the tappet roller, so as to realize the prevention of damage to the tappet roller.

### BRIEF DESCRIPTION OF THE DRAWINGS

FIG. 1 is a perspective view of a main part which shows Embodiment 1 of the invention;

FIG. 2 is a sectional view taken along the line A-A in FIG. 1;

FIG. 3 is a perspective view of a main part which shows Embodiment 2 of the invention;

FIG. 4 is a sectional view taken along the line B-B in FIG. 3;

FIG. 5 is a partial sectional view showing another example of a construction which prevents the dislocation of a needle from a pocket;

FIG. 6 is a perspective view of a main part which shows Embodiment 3 of the invention;

FIG. 7 is a sectional view taken along the line C-C in FIG. 6;

FIG. 8 is a perspective view of a main part which shows Embodiment 4 of the invention;

FIG. 9 is a sectional view taken along the line D-D in FIG. 8;

FIG. 10 is a sectional view of a main part which shows Embodiment 5 of the invention;

FIG. 11 is a sectional view of a main part which shows Embodiment 6 of the invention;

FIG. 12 is a perspective view of a cage removed;

FIG. 13 is a sectional view taken along the line E-E in FIG. 12;

FIG. 14 is a plan view which shows an intermediate material;

FIG. 15 is a sectional view of a main part which shows Embodiment 7 of the invention;

FIG. 16 is a sectional view of a device used for an experiment made to verify the effect of forming a carbonitride layer on an outer circumferential surface of a support shaft and a rolling surface of a respective needle;

FIG. 17 is a diagram which shows the results of the experiment;

FIG. 18 is a partial side view which shows an example of a valve train of an engine provided with a cam follower apparatus;

FIG. 19 is a sectional view taken along the line F-F in FIG. 18;

FIG. 20 is a sectional view taken along the line G-G in the same figure;

FIG. 21 is a perspective view with a rocker arm omitted;

FIG. 22 is a sectional view taken along the line H-H in FIG. 21;

FIG. 23 is a sectional view which shows a first example of a conventional construction with a cage;

FIG. 24 is a sectional view which shows a second example of the same; and

FIG. 25 is a similar view to FIG. 22 which shows the two examples of the conventional constructions.

### DESCRIPTION OF REFERENCE NUMERALS

1 camshaft; 2 cam; 3 rocker arm; 4 support wall; 5, 5a, 5b support shaft; 6 tappet roller; 7, 7a, 7b, 7c, 7d, 7e radial needle bearing; 8 needle; 9, 9a roller; 10, 10a, 10b, 10c, 10d, 10e, 10f, 10g cage; 11, 11a, 11b, 11c, 11d rim portion; 12, 12a, 12b, 12c, 12d pillar portion; 13 pocket; 14 head; 15 ring; 16 lubricating oil; 17a, 17b locking projecting piece; 18 inside diameter side cylindrical portion; 19 outside diameter side cylindrical portion; 20 sloping portion; 21 intermediate material; 22 locking projecting portion; 23 inside diameter side locking portion; 30 separator

### BEST MODE FOR CARRYING OUT THE INVENTION

### Embodiment 1

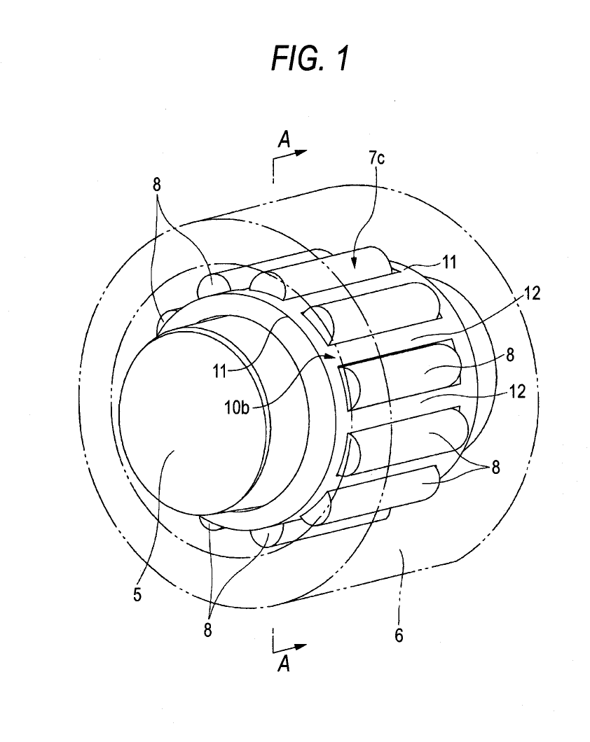

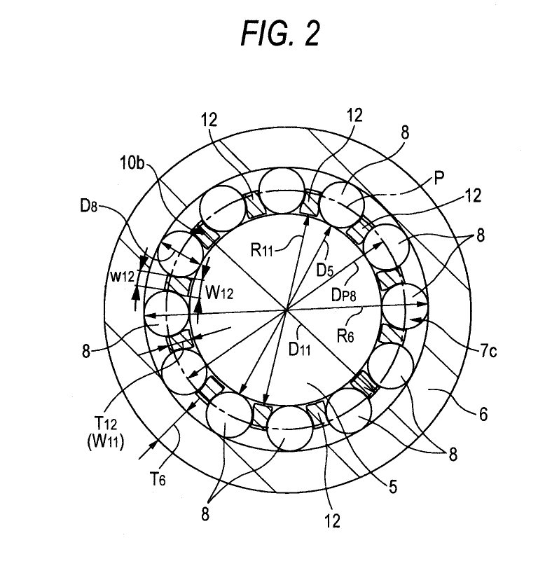

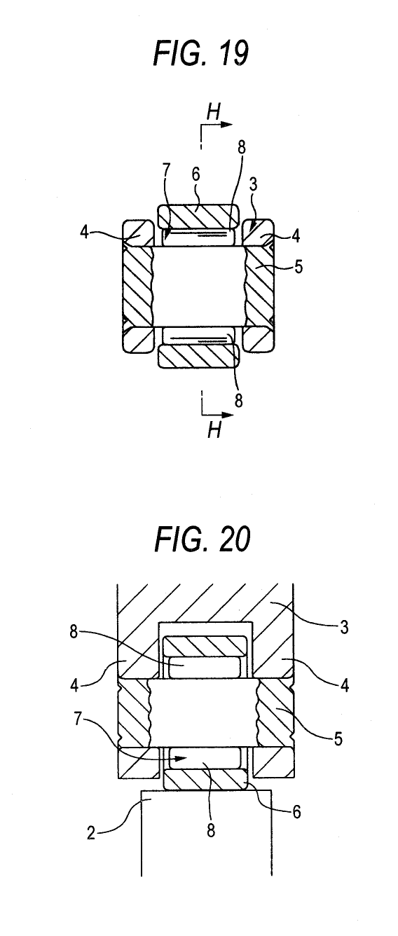

FIGS. 1 to 2 show Embodiment 1 of the invention. Note that a feature of this embodiment relates to the construction of a radial needle bearing 7c for rotatably supporting a tappet roller 6 on the periphery of a support shaft 5. Since the construction and function of the embodiment excluding the radial needle bearing 7c which includes where both end portions of the support shaft 5 are supported and fixed to support wall portions 4, 4 (refer to FIGS. 18 to 20) of a rocker arm 3 are similar to those of the conventional constructions shown in FIGS. 18 to 20, the repetition of similar illustrations and descriptions will be omitted or simplified, so that characteristic portions of the embodiment will mainly be described below.

In the case of this embodiment, 12 needles 8, 8 which make up the radial needle bearing 7c are held in such a manner as to freely roll by a basket-shaped cage 10b. This cage 10b is such as to be produced integrally by injection molding a synthetic resin and is made up of a pair of rim portions 11, 11 which are each formed into an annular shape and are disposed in parallel and concentrically with each other, and the same number (12) of pillar portions 12, 12, which are extended between internal surfaces of both the rim portions 11, 11, as needles 8, 8 to be held thereby. Note that there is no specific limitation on the kind of the synthetic resin. Various types of synthetic resins generally used to produce cages can be adopted. For example, since a Polyamide 46, which contains 20 to 30 wt % (preferably, 25 wt %) of glass fibers as a reinforcement material, has a heat resistance which can be used up to on the order of 150° C., the Polyamide 46 is suitable for incorporation into a cam follower apparatus for use in a valve train of an engine. On the other hand, since a Polyamide 66 is inexpensive and is superior in moldability, the Polyamide 66 is advantageous in terms of costs. However, even though glass fibers are made to be contained therein in the aforesaid range of quantities as a reinforcement material, since only a heat resistance up to on the order of 120° C. can be obtained, conditions where the relevant material is used need to be taken into consideration.

In the case of this embodiment, an inside diameter R₁₁ of both the rim portions 11, 11 is made slightly larger than an outside diameter D₅ of the support shaft 5 (R₁₁>D₅). In addition, an outside diameter D₁₁ of both the rim portions 11, 11 is made sufficiently smaller than an inside diameter R₆ of the tappet roller 6 (D₁₁<<R₆) but is made equal to a pitch circle diameter D_{P8} of the respective needles 8, 8 or substantially slightly larger than the pitch circle diameter D_{P8} (D₁₁≧D_{P8}). Furthermore, outer circumferential side surfaces of the respective pillar portions 12, 12 and outer circumferential edges of both the rim portions 11, 11 are positioned on a single cylindrical surface, and inner circumferential side surfaces of the respective pillar portions 12, 12 and inner circumferential edges of both the rim portions 11, 11 are position on a single cylindrical surface. Consequently, a thickness T₁₂ of the respective pillar portions 12, 12 relative to the radial direction of the cage 10b is equal to a thickness W₁₁ of both the rim portions 11, 11 (T₁₂=W₁₁).

In addition, a circumferential width dimension w₁₂ of a portion of the respective pillar portions 12, 12 which is positioned on a pitch circle P of the respective needle portions 8, 8 at an outside diameter side end portion of the respective pillar portions 12, 12 and is positioned between the needles 8, 8 which are adjacent to each other in the circumferential direction is made smaller than a width dimension W₁₂ of a portion of the respective pillar portions 12, 12 which is positioned closer to an inside diameter side thereof (W₁₂<W₁₂). By being configured like this, while a cross-sectional area of the respective pillar portions 12, 12 is secured, so as to secure the strength and rigidity of the respective pillar portions 12, 12, the rolling surfaces of the needles 8, 8 which are adjacent to each other in the circumferential direction are made to approach each other. Furthermore, by causing the inner circumferential edges of both the rim portions 11, 11 and the inner circumferential side surfaces of the respective pillar portions 12, 12 to approach and face an outer circumferential surface of the support shaft, the positioning of the cage 10b relative to the radial direction is realized (by virtue of a so-called inner ring riding).

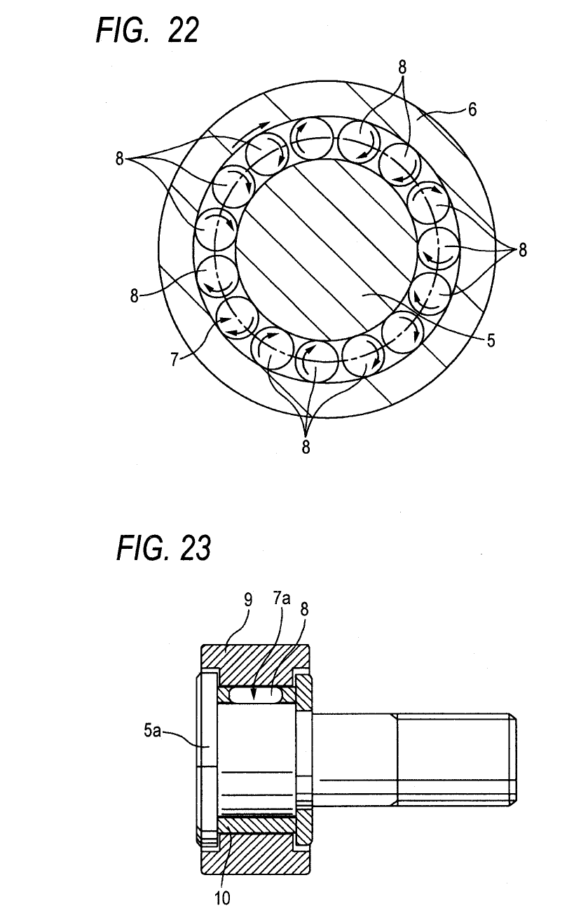

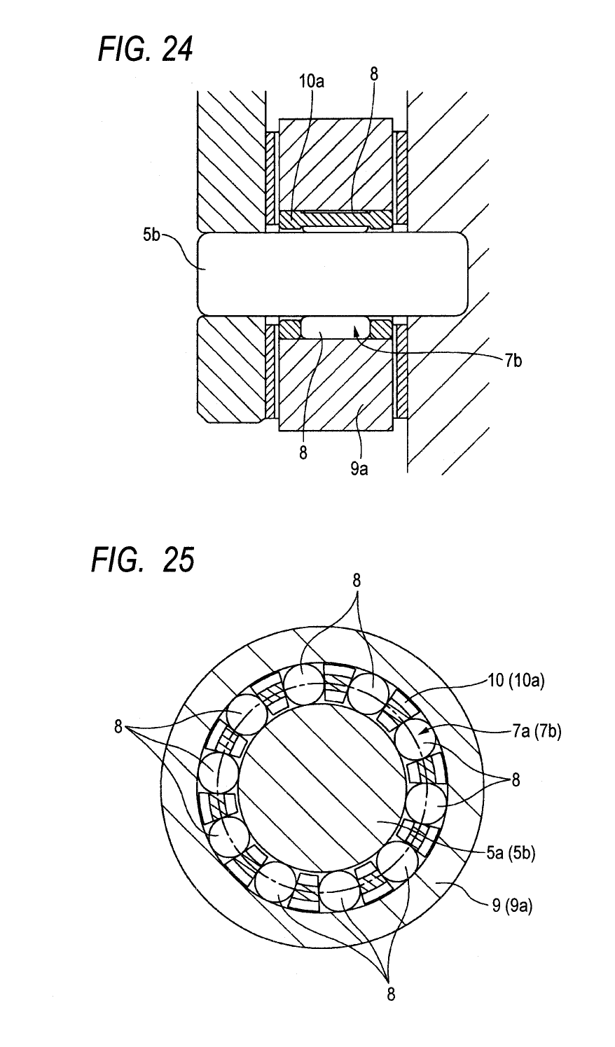

In this embodiment, by the configuration that has been described heretofore, the number of respective needles 8, 8 is made not to be decreased excessively while preventing the rolling surfaces of the needles 8, 8 which are adjacent to each other in the circumferential direction from rubbing against each other. Namely, as is shown in FIG. 22, which has been described before, when considering a case where on the order of 15 needles 8, 8 of the complete needle type are incorporated, as is shown in FIG. 25, which has been described before, when the cages 10, 10a, which were conventionally used, were used, only on the order of 10 needles 8, 8 could be incorporated in them. On the contrary to this, in the case of the embodiment, as has been described above, on the order of 12 needles 8, 8 can be incorporated. In addition, the wear of internal surfaces of the support walls 4, 4 are made to be prevented by providing both the rim portions 11, 11.

In the case of the cam follower apparatus of the embodiment which is configured as have been described heretofore, since the pillar portions 12, 12 of the cage 10b are present between the needles 8, 8 which are adjacent to each other in the circumferential direction, there occurs no case where the rolling surfaces of the respective needles 8, 8 are caused to rub against each other. Although the rolling surfaces of the respective needles 8, 8 rub against the circumferential side surfaces of the respective pillar portions 12, 12, since the respective pillar portions 12, 12 are not such as to revolve on their own axes as the respective needles 8, 8 do, the rubbing speed is slow when compared with that resulting where the rolling surfaces of the needles 8, 8 which are adjacent to each other in the circumferential direction are caused to rub against each other (is suppressed to ½ the latter rubbing speed). In addition, a friction coefficient of the sliding contact portion between the circumferential side surfaces of the respective pillar portions 12, 12, which make up the cage 10b made from synthetic resin, and the rolling surfaces of the respective needles 8, 8 is suppressed lower than a friction coefficient that results when the rolling surfaces of the needles 8, 8 are caused to rub against each other. Because of this, the dynamic torque of the radial needle bearing 7c is suppressed to a low level, whereby the rotational resistance of the tappet roller 6 is suppressed to a low level. As a result, an improvement in the performance of an engine which incorporates therein the cam follower apparatus of the embodiment can be realized which includes an improvement in the fuel consumption rate of the relevant engine.

Furthermore, since the thickness T₁₂ of the respective pillar portions 12, 12 is smaller than a diameter D₈ of the respective needles 8, 8 and moreover the radial position thereof is offset radially inwards relative to the pitch circle diameter of the respective needles 8, 8, the interval between the rolling surfaces of the needles 8, 8 which are adjacent to each other in the circumferential direction can be made smaller than the circumferential width dimension of the respective pillar portions 12, 12. In addition, the number (12) of needles 8, 8 to be disposed between the outer circumferential surface of the support shaft 5 and the inner circumferential surface of the tappet roller 6 can be secured. As a result, without increasing the thickness T₆ of the tappet roller 6 particularly largely, a bending stress generated in the tappet roller 6 when the engine is driven is suppressed to a low level, thereby making it possible to realize the prevention of a damage to the tappet roller 6. In addition, since the cage 10b made from synthetic resin is light in weight in addition to being easy to be molded and able to be obtained inexpensively, the engine incorporating the cam follower apparatus of the embodiment becomes advantageous in terms of low cost and high performance.

### Embodiment 2

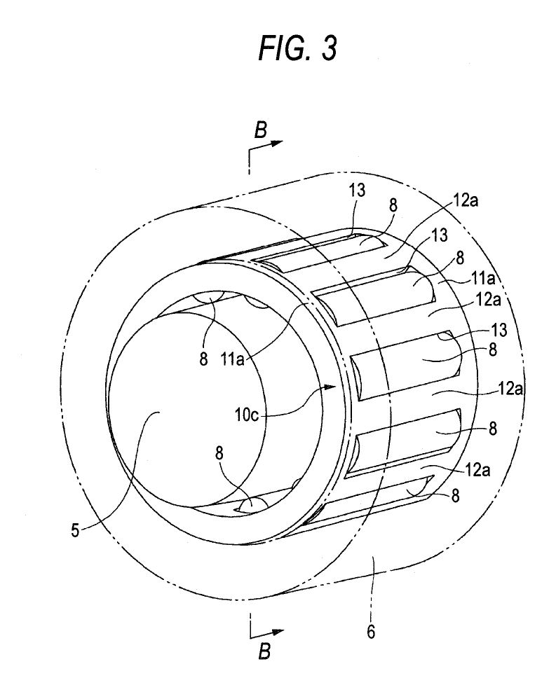

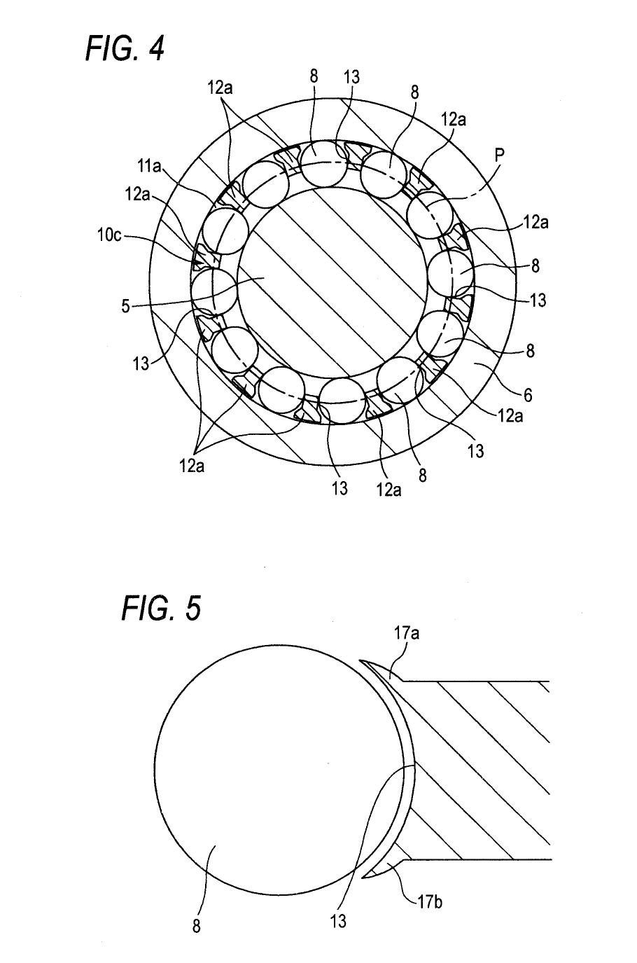

FIGS. 3 to 4 show Embodiment 2 of the invention. In the case of this embodiment, a pair of rim portions 11a, 11a and pillar portions 12a, 12a which are provided between both the rim portions 11a, 11a, which both make up a cage 10c, are disposed radially outwards relative to a pitch circle P of respective needles 8, 8. A width dimension of a radially outward end portion of the respective pillar portions 12a, 12a is made larger than a width dimension of a portion which lies closer to an inside diameter side thereof, so that an interval between circumferential edges at an outside diameter side end portion of the pillar portions 12a, 12a which are adjacent to each other in the circumferential direction is made sufficiently smaller than an outside diameter of the respective needles 8, 8. In addition, outer circumferential edges of both the rim portions 11a, 11a and outer circumferential side surfaces of the pillar portions 12a, 12a which are adjacent to each other in the circumferential direction are made to approach and face an inner circumferential surface of a tappet roller 6, so as to restrict a radial position of the cage 10c (by virtue of a so-called outer ring riding). In addition, radially inner end portions of the respective pillar portions 12a, 12a are positioned radially slightly further inwards than the pitch circle P, and an interval between circumferential edges of inside diameter side end portions of the pillar portions 12a, 12a which are adjacent to each other in the circumferential direction is made slightly smaller than the outside diameter of the respective needles 8, 8.

In the case of this embodiment configured as described above, the respective needles 8, 8 are built into pockets 13, 13 in the cage 10c from a radially inside of the cage 10c. As this occurs, the respective pillar portions 12a, 12 which are adjacent to each other in the circumferential direction are elastically deformed, so that a circumferential interval between the inside diameter side end portions of the respective pillar portions 12a, 12a is expanded. In a state resulting after the respective needles 8, 8 have been built into the respective pockets 13, 13, the circumferential interval between the inside diameter side end portions of the respective pillar portions 12a, 12a is contracted, and hence, there is caused no case where the respective needles 8, 8 are dislocated abruptly from the respective pockets 13, 13. Because of this, when the cage 10c and the plurality of needles 8, 8 which are held in the cage 10c are connected in such a manner as not to be separated from each other, since the cage 10c and the needles 8, 8 can be handled as a so-called cage-and-rollers, the simplification of parts control and improvement in assembling properties of a cam follower apparatus can be realized. In addition, since the radial position of the cage 10c is restricted by virtue of the outer ring riding, a sufficient amount of lubricating oil can be interposed in a rubbing portion between an outer circumferential surface of the cage 10c and an inner circumferential surface of the tappet roller 6. Namely, while the cam follower apparatus is being driven, lubricating oil is collected on to the inner circumferential surface of the tappet roller 6 by virtue of centrifugal force. Because of this, a friction at the rubbing portion between the outer circumferential surface of the cage 10c and the inner circumferential surface of the tappet roller 6 is reduced, so as to suppress the wear of both the circumferential surfaces. The configurations and functions of the other portions are similar to those of Embodiment 1 that has been described above.

Note that as a modification to this embodiment, the position of inner circumferential side surfaces of the respective pillar portions 12a, 12a can be positioned radially slightly further outwards than the position shown in FIG. 4 (closer to an outside diameter side thereof than the pitch circle P). In the case of the configuration like this being adopted, although the needles 8, 8 which are built into the respective pockets cannot be prevented from being dislocated therefrom radially inwards before they are built on to the support shaft 5, the interval between the needles 8, 8 which are adjacent to each other in the circumferential direction can be reduced, so that the number of needles 8, 8 can be increased which are to be built in between the outer circumferential surface of the support shaft 5 and the inner circumferential surface of the tappet roller 6. The construction like this constitutes a construction in which the needles 8, 8 and the cage are shifted to a radially opposite side relative to the pitch circle P of the needles 8, 8 in relation to Embodiment 1 that has been described above. In the event that the number of needles 8, 8 and the pitch circle diameter remain the same, the interval present between the needles 8, 8 which are adjacent to each other in the circumferential direction becomes larger on an inside diameter side than an outside diameter side of the pitch circle P. Consequently, the construction that has been described above is advantageous in that a cross-sectional area of the pillar portion is secured.

In addition, as a modification to this embodiment, locking projecting pieces 17a, 17b are formed at an outside diameter side opening and an inside diameter side opening of the pocket 13 in such a manner as to project towards the pocket 13, so as to realize the prevention of dislocation of the needle 8 from the pocket 13 by the respective locking projecting pieces 17a, 17b. When the needle 8 is built into an interior of the pocket 13, the needle 8 is pushed into the interior of the pocket while elastically deforming either of the locking projecting pieces 17a (17b) in the circumferential direction.

### Embodiment 3

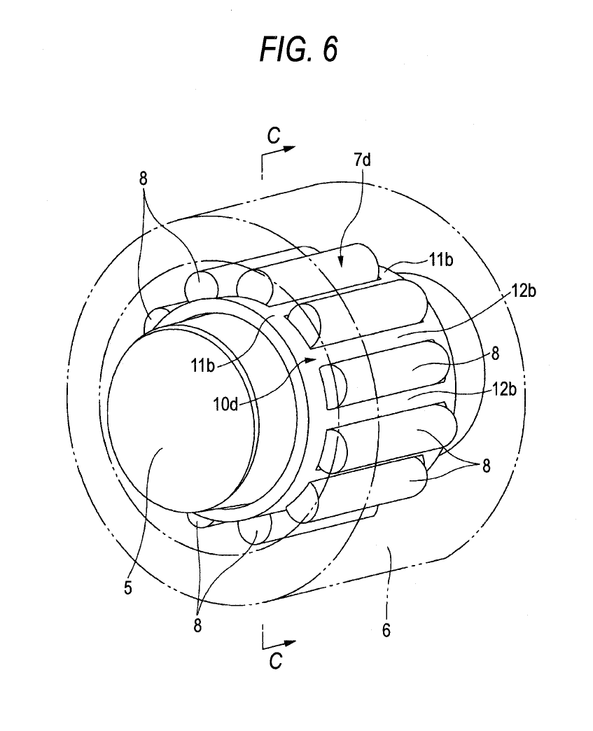

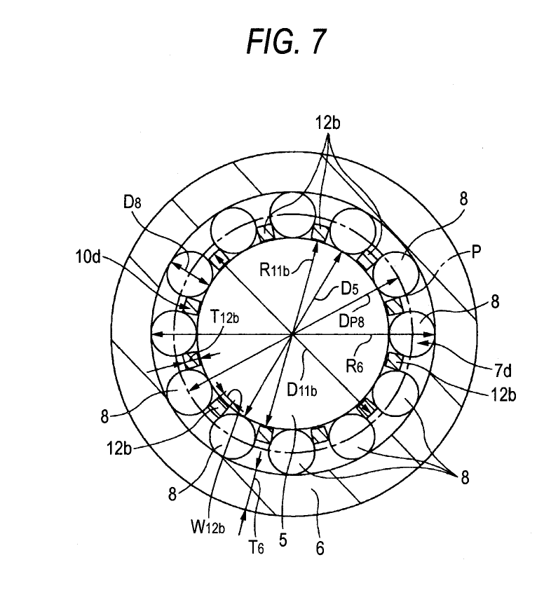

FIGS. 6 to 7 show Embodiment 3 of the invention. Note that a feature of this embodiment relates to the construction of a radial needle bearing 7d for rotatably supporting a tappet roller 6 on the periphery of a support shaft 5. Since the construction and function of the embodiment excluding the radial needle bearing 7d which includes where both end portions of the support shaft 5 are supported and fixed to support wall portions 4, 4 (refer to FIGS. 18 to 20) of a rocker arm 3 are similar to those of the conventional constructions shown in FIGS. 18 to 20, the repetition of similar illustrations and descriptions will be omitted or simplified, so that characteristic portions of the embodiment will mainly be described below.

In the case of this embodiment, 12 needles 8, 8 which make up the radial needle bearing 7d are held in such a manner as to freely roll by a basket-shaped cage 10d. This cage 10d is such as to be produced by blanking and bending a sheet material of an iron based alloy such as stainless steel or copper based alloy such as brass and is made up of a pair of rim portions 11b, 11b which are each formed into an annular shape and are disposed in parallel and concentrically with each other, and the same number (12) of pillar portions 12b, 12b, which are extended between internal surfaces of both the rim portions 11, 11, as needles 8, 8 to be held thereby.

In the case of this embodiment, an inside diameter R_{11b} of both the rim portions 11b, 11b and a diameter of an inscribed circle of the respective pillar portions 12b, 12b are made slightly larger than an outside diameter D₅ of the support shaft 5 (R₁₁>D₅). In addition, an outside diameter D_{11b} of both the rim portions 11b, 11b and a diameter (D_{11b}) of a circumscribed circle of the respective pillar portions 12b, 12b are made sufficiently smaller than an inside diameter R₆ of the tappet roller 6 and a pitch circle diameter D_{P80} the respective needles 8, 8 (D₁₁<<D_{P8}<<R₆). Furthermore, outer circumferential side surfaces of the respective pillar portions 12b, 12b and outer circumferential surfaces of both the rim portions 11b, 11b are positioned on a single cylindrical surface, and inner circumferential side surfaces of the respective pillar portions 12b, 12b and inner circumferential surfaces of both the rim portions 11b, 11b are position on a single cylindrical surface. In short, the whole of the cage 10d which includes the respective pillar portions 12b, 12b is positioned sufficiently radially further inwards than a pitch circle P of the respective needles 8, 8, whereby while securing a circumferential width dimension W_{12b} of the respective pillar portions 12b, 12b, so as to secure the rigidity of the respective pillar portions 12b, 12b, rolling surfaces of the needles 8, 8 which are adjacent to each other in the circumferential direction can be caused to approach each other. Furthermore, inner circumferential edges of both the rim portions 11b, 11b and the inner circumferential side surfaces of the respective pillar portions 12b, 12b are caused to approach and face an outer circumferential surface of the support shaft 5, whereby a radial positioning of the cage 10d is attained (by virtue of the so-called inner ring riding).

In this embodiment, by the configuration that has been described heretofore, the number of respective needles 8, 8 is made not to be decreased excessively while preventing the rolling surfaces of the needles 8, 8 which are adjacent to each other in the circumferential direction from rubbing against each other. Namely, as is shown in FIG. 22, which has been described before, when considering a case where on the order of 15 needles 8, 8 of the complete needle type are incorporated, as is shown in FIG. 25, which has been described before, when the cages 10, 10a, which were conventionally used, were used, only on the order of 10 needles 8, 8 could be incorporated in them. On the contrary to this, in the case of the embodiment, as has been described above, on the order of 12 needles 8, 8 can be incorporated. In addition, the wear of internal surfaces of the support walls 4, 4 are made to be prevented by providing both the rim portions 11b, 11b.

In the case of the cam follower apparatus of the embodiment which is configured as have been described heretofore, since the pillar portions 12b, 12b of the cage 10d are present between the needles 8, 8 which are adjacent to each other in the circumferential direction, there occurs no case where the rolling surfaces of the respective needles 8, 8 are caused to rub against each other. Although the rolling surfaces of the respective needles 8, 8 rub against the circumferential side surfaces of the respective pillar portions 12b, 12b, since the respective pillar portions 12b, 12b are not such as to revolve on their own axes as the respective needles 8, 8 do, the rubbing speed is slow when compared with that resulting where the rolling surfaces of the needles 8, 8 which are adjacent to each other in the circumferential direction are caused to rub against each other (is suppressed to ½ the latter rubbing speed). Because of this, the dynamic torque of the radial needle bearing 7d is suppressed to a low level, whereby the rotational resistance of the tappet roller 6 is suppressed to a low level. As a result, an improvement in the performance of an engine which incorporates therein the cam follower apparatus of the embodiment can be realized which includes an improvement in the fuel consumption rate of the relevant engine.

Furthermore, since the thickness T_{12b} of the respective pillar portions 12b, 12b is sufficiently smaller than a diameter D₈ of the respective needles 8, 8 (T_{12b}≦D₈), and moreover the radial position thereof is offset radially inwards relative to the pitch circle diameter of the respective needles 8, 8, the interval between the rolling surfaces of the needles 8, 8 which are adjacent to each other in the circumferential direction can be made smaller than the circumferential width dimension W_{12b} of the respective pillar portions 12b, 12b. In addition, the number (12) of needles 8, 8 can be secured which are to be disposed between the outer circumferential surface of the support shaft 5 and the inner circumferential surface of the tappet roller 6. As a result, without increasing the thickness T₆ of the tappet roller 6 particularly largely, a bending stress generated in the tappet roller 6 when the engine is driven is suppressed to a low level, thereby making it possible to realize the prevention of a damage to the tappet roller 6.

### Embodiment 4

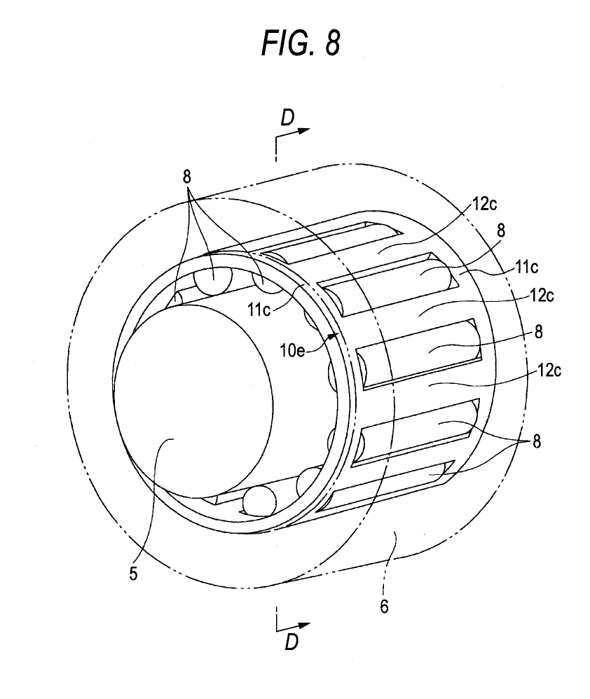

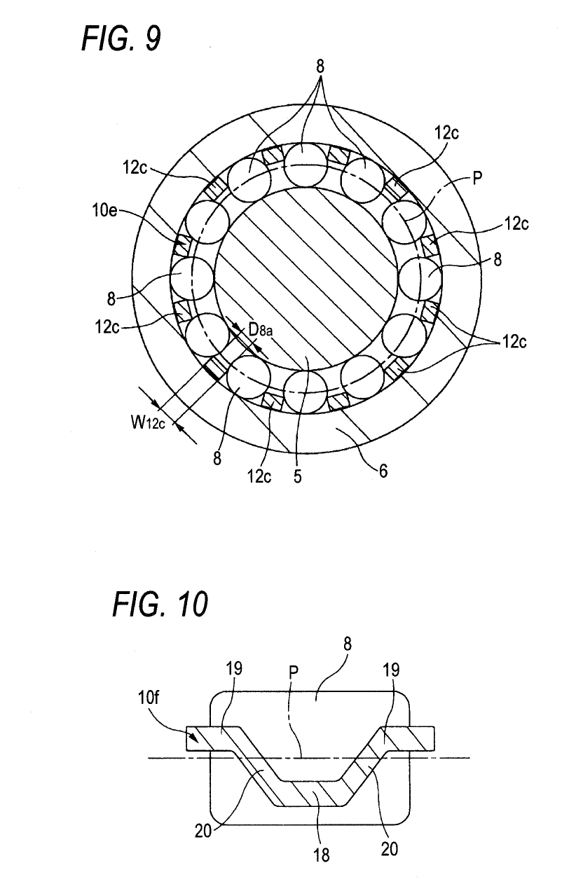

FIGS. 8 to 9 also show Embodiment 4 of the invention. In the case of this embodiment, a pair of rim portions 11c, 11c and pillar portions 12c, 12c which are provided between both the rim portions 11a, 11a, which both make up a cage 10g, are disposed sufficiently radially outwards relative to a pitch circle P of respective needles 8, 8. The cage 10g of the embodiment is also such as to be produced by blanking and bending a sheet material of an iron based alloy such as stainless steel or copper based alloy such as brass, and outer circumferential side surfaces of the respective pillar portions 12c, 12c and outer circumferential surfaces of both the rim portions 11c, 11c are positioned on a single cylindrical surface, and inner circumferential side surfaces of the respective pillar portions 12c, 12c and inner circumferential surfaces of both the rim portions 11c, 11c are position on a single cylindrical surface.

In addition, the outer circumferential surfaces of both the rim portions 11c, 11c and the outer circumferential side surfaces of the pillar portions 12c, 12c are made to approach and face an inner circumferential surface of a tappet roller 6, so as to restrict a radial position of the cage 10g (by virtue of a so-called outer ring riding). In addition, inner circumferential surfaces of the respective pillar portions 12c, 12c are positioned radially sufficiently further outwards than the pitch circle P, and an interval D a between rolling surfaces of the needles 8, 8 which are adjacent to each other in the circumferential direction is made sufficiently shorter than a circumferential width dimension W_{12c} of the respective pillar portions 12c, 12c (D₈ₐ≦W_{12c}).

In the event that the configuration described above is adopted, the interval between the needles 8, 8 which are adjacent to each other in the circumferential direction can be reduced more than the case of Embodiment 3 described above, so that the number of needles 8, 8 can be increased which are to be built in between an outer circumferential surface of a support shaft 5 and the inner circumferential surface of the tappet roller 6. Namely, the construction of this embodiment constitutes a construction in which the respective pillar portions 12c, 12c are shifted to a radially opposite side relative to the pitch circle P of the needles 8, 8 in relation to Embodiment 3 that has been described above. In the event that the number of needles 8, 8 and the pitch circle diameter remain the same, the interval present between the needles 8, 8 which are adjacent to each other in the circumferential direction becomes larger on an outside diameter side than an inside diameter side of the pitch circle P. Consequently, the construction of the embodiment is advantageous in that the interval between the needles 8, 8 which are adjacent to each other in the circumferential direction is made short (the number of needles is increased) while securing a cross-sectional area of the pillar portion.

In addition, in the case of this embodiment, since the radial position of the cage 10c is restricted by virtue of the outer ring riding, a sufficient amount of lubricating oil can be interposed in a rubbing portion between an outer circumferential surface of the cage 10g and an inner circumferential surface of the tappet roller 6. Namely, while the cam follower apparatus is being driven, lubricating oil is collected on to the inner circumferential surface of the tappet roller 6 by virtue of centrifugal force. Because of this, a friction at the rubbing portion between the outer circumferential surface of the cage 10g and the inner circumferential surface of the tappet roller 6 is reduced, so as to suppress the wear of both the circumferential surfaces. In addition, in order to secure a more sufficient amount of lubricating oil at this rubbing portion, sloping surfaces which slopes more radially inwards as they extend closer to edges are preferably formed at portions on the outer circumferential surfaces of the respective pillar portions 12c, 12c which lie closer to circumferential edges thereof. By forming such sloping surfaces, both the circumferential edges of the respective pillar portions 12c, 12c are prevented from scraping too much the lubricating oil adhering to the inner circumferential surface of the tappet roller 6, whereby the lubricating oil present in the rubbing portion can be secured. Note that the technique for forming the sloping surfaces can also be applied to the Embodiment 3 (the inside and outside being reversed relative to the radial direction) that has been described before, as well as Embodiments 5, 6 which will be described next.

### Embodiment 5

FIG. 10 shows Embodiment 5 of the invention. In the case of this embodiment, as a cage 10f, a cage is used in which a sectional shape of a laterally intermediate portion is bent into a trapezoidal shape. Namely, an inside diameter side cylindrical portion 18 which is formed at a longitudinally central portion and outside diameter side cylindrical portions 19 which are formed, respectively, at both lateral end portions are connected continuously by sloping portions 20, 20, respectively. Among these, the inside diameter cylindrical portion 18 is present radially more inwards than a pitch circle P of a needle 8, and the outside diameter side cylindrical portions 19, 19 are present radially more outwards than the pitch circle P. In addition, a pocket for holding the needle 8 in such a manner as to freely roll is provided in such a state that the pocket is extended between inner half portions of both the outside diameter side cylindrical portions 19, 19. Locking projecting pieces are formed in such a manner as to project into the pocket in positions on both circumferential edges of both the outside diameter side cylindrical portions 19, 19 and both circumferential edges of the inside diameter side cylindrical portion 18 which are aligned with each other. An interval between the locking projecting pieces which project into the pocket in a free state is made slightly smaller than an outside diameter of the needle 8.

In the case of this embodiment configured in this way, when the needle 8 is pushed into the pocket of the cage 10f from a radial direction, the respective locking projecting pieces are elastically deformed so that the intervals between the distal edges of the locking projecting pieces which face each other in the circumferential direction are expanded. In a state where the needle 8 has been built in the pocket, the circumferential intervals between the distal edges of the respective locking projecting pieces are contracted, whereby there occurs no case where the needle 8 is not dislocated abruptly from the interior of the pocket. Because of this, since the cage 10f and the plurality of needles 8 are handled as the so-called cage-and-rollers in which the cage 10f and the plurality of needles 8 are connected in such a manner as not to be separated from each other, the simplification of parts control and improvement in assembling properties of the cam follower can be attained. In the case of this embodiment configured in this way, the radial positioning of the cage 10f is attained by virtue of a so-called rolling elements riding, which is attained, in turn, by virtue of engagement of the respective locking projecting pieces with a rolling surface of the needle 8. The configurations and function of the other portions are similar to those of Embodiments 3, 4 which have been described above.

### Embodiment 6

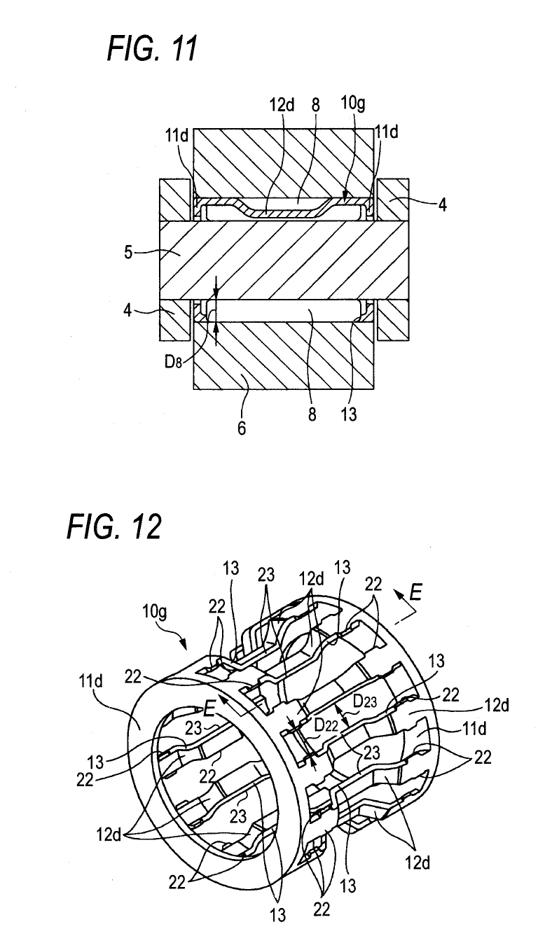

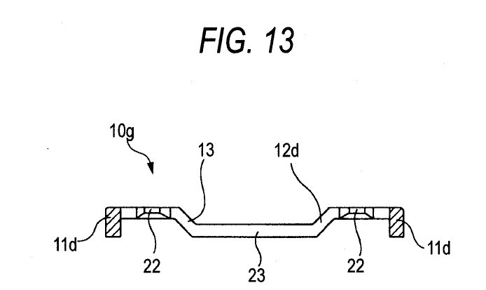

FIGS. 11 to 14 also show Embodiment 6 of the invention. As is shown in FIGS. 12 to 13, a cage 10g includes a pair of rim portions 11d, 11d, each formed into a circular ring shape, which are disposed in such a manner as to be spaced apart from each other in an axial direction (in a lateral direction as viewed in FIGS. 11 to 13) and a plurality of pillar portions 12d, 12d. These respective pillar portions 12d, 12d are disposed at intervals along a circumferential direction and are connected at both end portions thereof continuously to portions on internal surfaces of both the rim portions 11d, 11d which face each other, the portions lying closer to outside diameter sides of the internal surfaces. In addition, the respective pillar portions 12d, 12d have a configuration in which an axial intermediate portion is bent radially inwards into a trapezoidal shape. Then, space portions which are surrounded by both circumferential edges of the respective pillar portions 12d, 12d which are adjacent to each other in the circumferential direction and internal surfaces of both the rim portions 11d, 11d which face each other are made into pockets 13, 13, respectively, and respective needles 8, 8 are held in the respective pockets 13, 13 in such a manner as to roll freely therein.

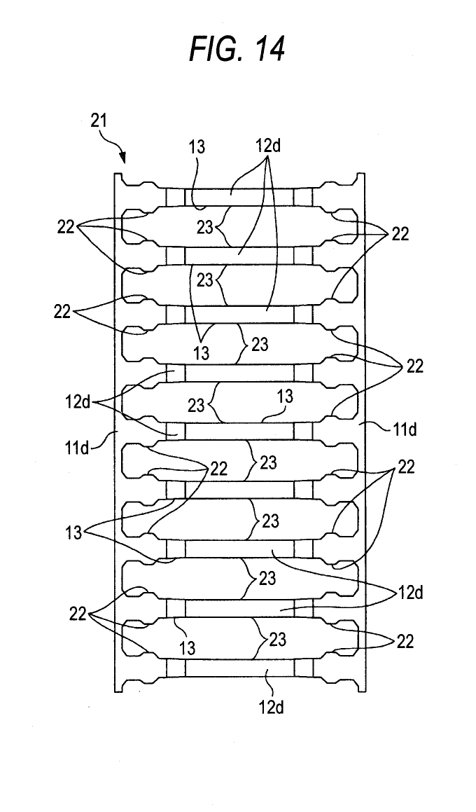

As is conventionally known as described in Patent Document No. 4, the cage 10g, which is configured in the way described heretofore, is made up by rounding a metal strap (generally a steel strap or stainless steel strap) into a cylindrical shape. Namely, although illustration is omitted, a metal strap is pressed into a first-stage intermediate material having a basic cross section as a cage, thereafter, this first-stage intermediate material is sheared to be stamped so as to form therein pockets 13, 13 for holding the respective needles 8, 8 in such a manner as to roll freely, whereby a second-stage intermediate material is produced. Furthermore, the second-stage intermediate material is cut to a predetermined length, so as to be made into a third-stage intermediate material 21 as is shown in FIG. 14.

Then, this third-stage intermediate material 21 is rounded into a cylindrical shape, and both end portions thereof are butt welded, whereby the third-stage intermediate material 21 is formed into a cage 10g as is shown in FIG. 12. In the case of this embodiment, in order to restrict a radial position of the cage 10g, an outer circumferential surface of this cage 10g is made to approach and face an inner circumferential surface of a tappet roller 6 (refer to FIG. 11). Then, when driven, the outer circumferential surface of the cage 10g, which is made to so approach and face, is guided (the outer ring riding) to the inner circumferential surface of the tappet roller 6, whereby the radial position of the cage 10g is attained, so as to prevent the generation of vibrations and abnormal noise.

In addition, the cage 10g has locking projecting portions 22, 22 formed on both side edges of both end portions of the respective pillar portions 12d, 12d in positions which are aligned with each other relative to the circumferential direction in such a state that the locking projecting portions project from respective side surfaces of the respective pillar portions 12d, 12d in the circumferential direction. These respective locking projecting portions 22, 22 are intended to prevent the dislocation of the respective needles 8, 8 which are held in the respective pockets 13, 13 in such a manner as to roll freely from the relevant pockets 13, 13 in a radially outward direction. Namely, when the respective needles 8, 8 are built in between an outer circumferential surface of a support shaft 5 and the inner circumferential surface of the tappet roller 6 together with the cage 10g, these respective needles 8, 8 are held in the respective pockets 13, 13 in such a state that the respective needles 8, 8 are prevented from being dislocated in the radial direction.

Because of this, the respective locking projecting portions 22, 22 are provided on openings of the respective pockets 13, 13 at portions lying more radially outwards than a pitch circle of the respective needles 8, 8 in such a state that the respective locking projecting portions 22, 22 face each other. An interval D₂₂ (refer to FIG. 12) between distal edges of the respective locking projecting portions 22, 22 is made smaller than an outside diameter D₈ (refer to FIG. 11) of the respective needles 8, 8 (D₈>D₂₂). In addition, in conjunction with this, an interval D₂₃ (refer to FIG. 12) between side edges, which face each other, of inside diameter side locking portions 23, 23 which are situated more radially inwards than the pitch circle of the respective needles 8, 8 is also made smaller than the outside diameter D8 of the respective needles D₈ (D₈>D₂₃).

When holding the respective needles 8, 8 in the respective pockets 13, 13, the respective needles 8, 8 are pushed into the respective pockets 13, 13 from an inside diameter side of the cage 10g. As this occurs, the intervals D₂₃ between the side edges of the inside diameter side locking portions 23, 23 are elastically expanded, so that the respective needles 8, 8 are passed between the side edges. With the respective needles 8, 8 held in the respective pockets 13, 13, the respective needles 8, 8 are prevented from being dislocated from the cage 10g in the radially inward direction by the respective locking projecting portions 22, 22 and in the radially outward direction by the side edges of the inside diameter side locking portions 23, 23 of the respective pillar portions 12d, 12d, respectively. In this respect, the construction of this embodiment is similar to that of Embodiment 5 which has been described above. In the case of this embodiment, in association with forming both the rim portions 11d, 11d into the circular ring shape, the rigidity of the cage 10g is secured while suppressing an axial dimension of the respective rim portions 11d, 11d to a small magnitude. Consequently, in the case of this embodiment, in the event that the rigidity of the cage 10g is made the same as that of Embodiment 5 described above, an axial length of the respective pockets 13, 13 is increased, so that a length dimension of the respective needles 8, 8 which are held within the respective pockets 13, 13 can be increased. The configurations and functions of the other portions are similar to those of Embodiment 5.

### Embodiment 7

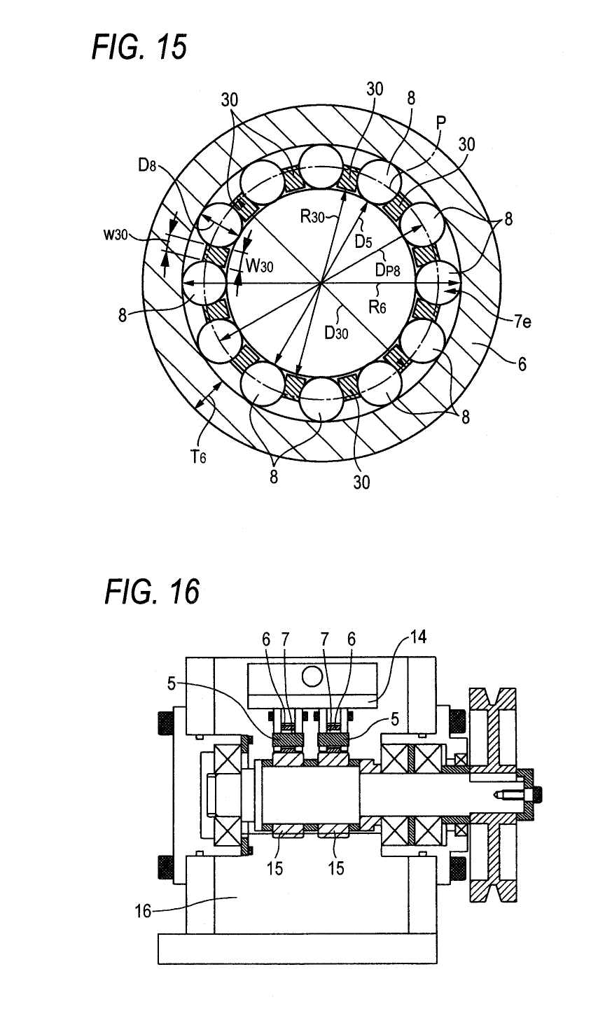

FIG. 15 also shows Embodiment 7 of the invention. In a radial needle bearing 7e of this embodiment, rod-shaped separators 30, which are independent of each other, as separating elements are disposed between needles 8, 8 which are adjacent to each other in a circumferential direction in such a manner as to parallel to a center axis of a support shaft 5. The respective separators 30 of this embodiment are each made from a synthetic resin and each have a similar cross section to that of the pillar portion 12 of Embodiment 1. Namely, an outside diameter D₃₀ is made slightly larger than an outside diameter D₅ of the support shaft 5 (D₃₀>D₅). In addition, the outside diameter D₃₀ is made sufficiently smaller than an inside diameter R₆ of the tappet roller 6 (D₃₀≦D₆), and is made equal to a pitch circle diameter D_{P8} of the respective needles 8, 8 or substantially slightly larger than the pitch circle diameter D_{P8} (D₃₀≧D_{P8}). In addition, a circumferential width dimension w₃₀ of outside diameter side end portions of the respective separators 30, 30 which are situated on the pitch circle P of the respective needles 8, 8 and are situated between the needles 8, 8 which are adjacent to each other in the circumferential direction is made smaller than a width dimension W30 of portions of the respective separators 30, 30 which are situated closer to an inside diameter side thereof (w₃₀<W₃₀).

In the case of the construction which utilizes the separators 30, 30 configured described above, although axial end faces of the respective needles 8, 8 cannot be prevented from butting part of sides of the rocking member, in stead, an axial dimension of the respective needles 8, 8 can be increased (by an extent which equals the thickness of the rim portions, when compared with a case where a cage with rim portions is used). The butting of the axial end faces of the respective needles 8, 8 against part of the sides of the rocking member does not constitute a specific problem in the event that the rocking member is made of a steel or hart metal, or a washer made from a hard metal or synthetic resin is provided on portions of part of the sides which face the axial end faces of the respective needles 8, 8. The increase in the axial dimension of the respective needles 8, 8 results in an increase in the load carrying capacity of the radial needle bearing 7e, which leads to an increase in durability of the cam follower apparatus. In addition, in the event that the load carrying capacity remains the same, the axial dimensions of the radial needle bearing 7e and the tappet roller can be decreased (by an extent equaling the axial dimension of the rim portions), thereby making it possible to attain the miniaturization and reduction in weight of the cam follower apparatus.

The configurations and functions of the other portions are similar to those of Embodiment 1. In addition, the material of the separators may be metal and the cross-sectional shape thereof can be modified appropriately according to materials as with the cages of the embodiments.

In addition, when carrying out the invention, forming a carbonitride layer on at least either the outer circumferential surface of the support shaft or the rolling surfaces of the respective needles 8, 8 is advantageous from the view point of preventing a damage to these outer circumferential surface and the rolling surfaces to thereby increase the durability of the cam follower apparatus. FIG. 16 shows an apparatus used in an experiment for verifying the advantage provided by forming the carbonitride layer above. In this experiment apparatus, a tappet roller 6, which is supported rotatably on the periphery of a support shaft 5 supported in turn on a head 14 by a radial needle bearing 7, is allowed to be pushed by a desired load against an outer circumferential surface of a ring 15 which corresponds to a cam. In addition, a lower end portion of the ring 15 is submerged in lubricating oil 16 which is reserved in a lower portion of the apparatus. When carrying out the experiment, the ring 15 is rotated at a desired rotational speed while pushing the tappet roller 6 against the outer circumferential surface of the ring by a predetermined pressure. Then, a damage was cased on to the radial needle bearing 7 based on separation, and as a result, a time (a service life) was measured which was taken until remarkable vibrations were generated.

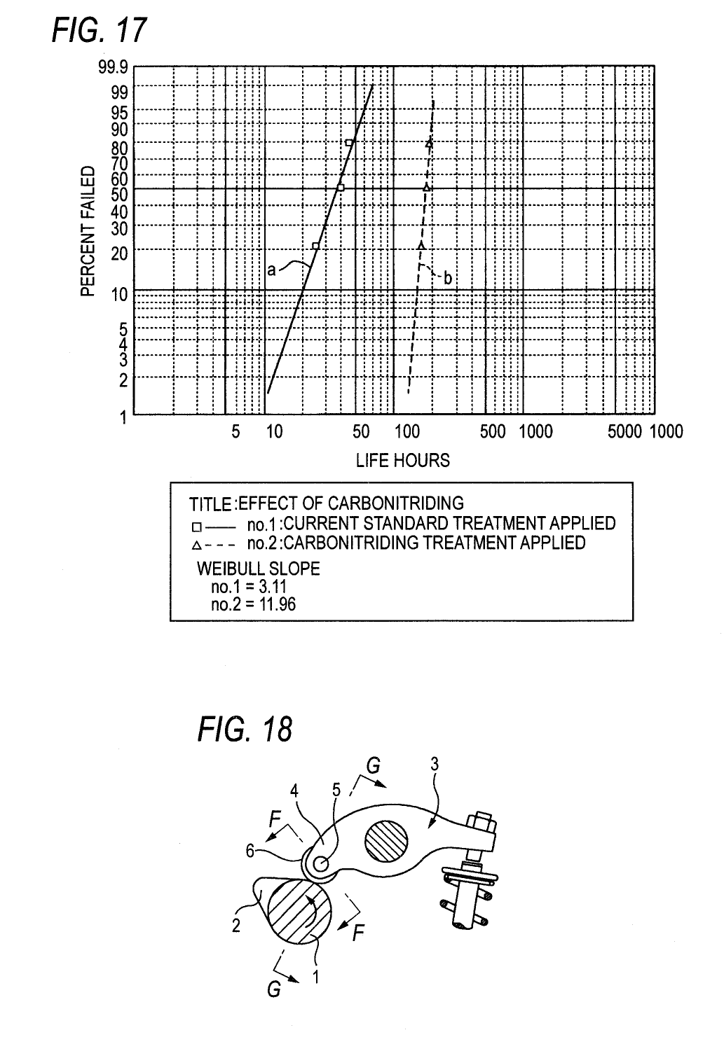

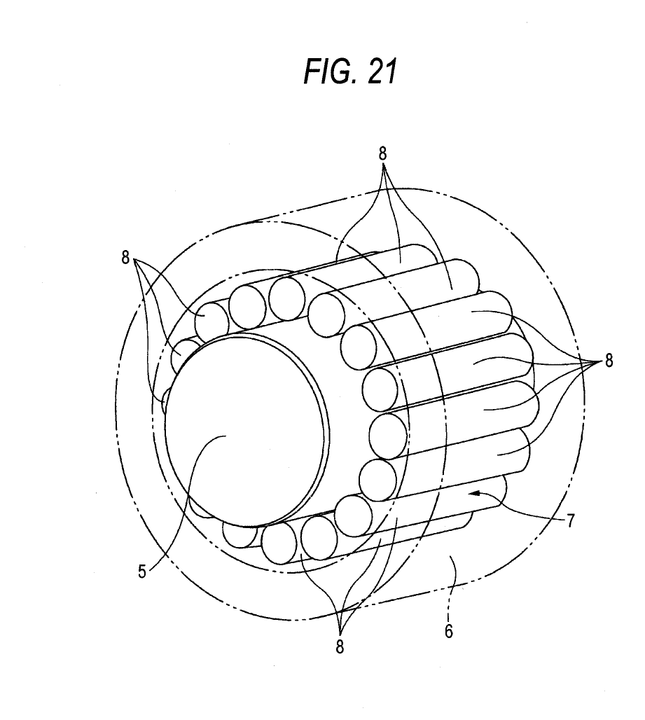

The results of the experiment which was carried out in the way described above are shown in FIG. 17. In FIG. 17, an axis of abscissa represents life of the radial needle bearing 7, while an axis of ordinate represents a ratio of samples which reached their lives to a plurality of samples tested. A complete needle type radial needle bearing 7 as shown in FIGS. 21 to 22 was used in the experiment whose results are shown in FIG. 17 which shows them in the way described above. In addition, the rotational speed of the ring 15 was 5000 min⁻¹, the load added was 0.3 C, the lubricating oil 16 used was an engine oil of 5W-20, and the temperature of the lubricating oil 16 was 100° C. In FIG. 17 showing the results of the experiment carried out in the conditions described above, a solid line a indicates a case where a standard heat treatment (a so-called quenching by through hardening) was applied to the support shaft 5 and the respective needles 8, 8, and a broken line b indicates a case where a carbonitriding treatment was applied to the support shaft 5 and the respective needles 8, 8 (a carob-nitrided layer was formed on the surface and rolling surfaces).

As is obvious from the results of the experiment like this, when compared with the case where the standard heat treatment was applied, the life can be extended about 7 times by the application of carbonitriding treatment. Since the life can be extended in this way, even though the durability tends to be reduced as a result of reduction in the number of needles due to provision of a cage or separator, the reduction in durability can sufficiently be compensated for by applying the carbonitriding treatment to the support shaft 5 and the respective needles 8, 8. In addition, although it is preferable to apply the carbonitriding treatment to both the support shaft 5 and the respective needles 8, 8, the advantage described above can be obtained to some extent by applying the relevant treatment to only either of them. Consequently, whether or not a carbonitriding treatment is to be applied, if applied, to which portion the relevant treatment is to be applied are determined while taking into consideration costs and durability required. In addition, as for the tappet roller 6, although the carbonitriding treatment is not necessarily applied to the roller, whether or not the treatment is to be applied to both in order to obtain a superior durability can be determined freely.

Note that the invention is not limited to the embodiments that have been described heretofore but can be modified and improved appropriately. In addition, the subject patent application is based on the Japanese Patent Application (No. 2005-005909) filed on Jan. 13, 2005 and the Japanese Patent Application (No. 2005-012831) filed on Jan. 20, 2005, and the contents thereof are incorporated herein by reference.

1. A cam follower apparatus, which is provided so as to face a cam fixed to a camshaft rotating in synchronous with a crankshaft of an engine and which rocks to be displaced in accordance with motions of the cam, comprising:
a support shaft of which end portions are supported on a rocking member; and
a tappet roller rotatably supported on the periphery of the support shaft via a radial needle bearing, wherein
a plurality of needles of the radial needle bearing are separated apart by separating elements which are disposed between the needles so as to be parallel to a center axis of the support shaft which are adjacent to each other in a circumferential direction in such a state that rolling surfaces of the adjacent needles do not contact with each other,
a thickness of the respective separating elements in a radial direction of the support shaft and the tappet roller is smaller than a diameter of the respective needles,
one of internal and external sides of the respective separating element is sliding contact with or faces closely one of an inner circumferential surface of the tappet roller and an outer circumferential surface of the support shaft so as to attain the positioning relative to the radial direction, and
a space, which is larger than a space existing between the one side and the one circumferential surface, exits between the other side of the internal and external sides of the respective separating element and the other circumferential surface of the inner circumferential surface of the tappet roller and the outer circumferential surface of the support shaft.

2. The cam follower apparatus as set forth in claim 1, wherein the respective separating element is a pillar portion which makes up a window type cage, and
a pair of rim portions, to which both end portions of the respective pillar portion are connected, is disposed, respectively, between both axial end faces of the respective needle and internal sides of a pair of support wall portions which are provided on a rocking member for supporting and fixing both end portions of the support shaft.

3. The cam follower apparatus as set forth in claim 2, wherein a locking portion is provided on an inner surface of a respective pocket which is surrounded on four sides thereof by pillar portions which are adjacent to each other in a circumferential direction and the pair of rim portions for preventing the dislocation of the needle held within the respective pockets from the pocket.

4. The cam follower apparatus as set forth in claim 1, wherein the respective separating elements are rod-like separators which are independent of each other.

5. The cam follower as set forth in claim 1, wherein a carbonitride layer is formed on at least one surface of the outer circumferential surface of the support shaft and the rolling surface of the respective needles.

6. The cam follower as set forth in claim 2, wherein a carbonitride layer is formed on at least one surface of the outer circumferential surface of the support shaft and the rolling surface of the respective needles.

7. The cam follower as set forth in claim 3, wherein a carbonitride layer is formed on at least one surface of the outer circumferential surface of the support shaft and the rolling surface of the respective needles.

8. The cam follower as set forth in claim 4, wherein a carbonitride layer is formed on at least one surface of the outer circumferential surface of the support shaft and the rolling surface of the respective needles.
